(19) United States
(12) Patent Application Publication
(10) Pub. No.: US 2021/0265609 A1
(43) Pub. Date: Aug. 26, 2021

(54) METHOD FOR MANUFACTURING ELECTRODE SHEET

(71) Applicant: TOYOTA JIDOSHA KABUSHIKI KAISHA, Toyota-shi (JP)

(72) Inventor: Yu TOYOSHIMA, Nisshin-shi (JP)

(21) Appl. No.: 16/953,442

(22) Filed: Nov. 20, 2020

(30) Foreign Application Priority Data
Feb. 20, 2020 (JP) 2020-027028

(51) Int. Cl. H01M 4/04; H01M 4/36; H01M 4/66; H01M 10/0525

(52) U.S. Cl. CPC H01M 4/0404; H01M 4/364; H01M 10/0525; H01M 4/366; H01M 4/661

(57) ABSTRACT

Coating materials of an electrode mixture layer and of the protective insulating layer are provided and coated adjacent to each other on a current collector foil. After coating, the coating materials of the electrode mixture layer and of the protective insulating layer on the current collector foil are dried to manufacture an electrode sheet having the current collector foil, and the electrode mixture layer and the protective insulating layer disposed, adjacent to each other, thereon. Here, in coating, the coating thickness of the coating material of the protective insulating layer is made smaller than the coating thickness of the coating material of the electrode mixture layer. After coating and until drying, both the coating materials of the electrode mixture layer and of the protective insulating layer are in contact with each other still in a wet state on the current collector foil.

### CROSS-REFERENCE TO RELATED APPLICATION

This application claims priority to Japanese Patent Application No. 2020-027028 filed on Feb. 20, 2020, incorporated herein by reference in its entirety.

### BACKGROUND

### 1. Technical Field

The present disclosure relates to a method for manufacturing an electrode sheet, which is a component of a battery. The present disclosure specifically relates to a method for manufacturing an electrode sheet having a configuration in which an electrode mixture layer and a protective insulating layer are disposed on a current collector foil.

### 2. Description of Related Art

Electrode sheets have been conventionally manufactured by coating. One example is Japanese Patent Application Publication No. 2015-213073. In a technique of the literature, a paste for an electrode layer (positive electrode paste) is coated on a current collector foil, and a paste (alumina paste) for a protective insulating layer (alumina-containing layer) is further coated thereon. An alumina-containing layer thus formed is said to prevent short circuits due to separation or drop-off of components of the electrode layer.

### SUMMARY

However, the foregoing conventional technique would cause the following problems. Referring to FIG. 1 of the literature, a sectional shape is drawn in which an alumina-containing layer (40) rides on an electrode layer (12) at a border between the electrode layer (12) and the alumina-containing layer (40). With such a shape, even when an electrode sheet is observed from above, an area where the electrode layer is present cannot be clearly discerned. For this reason, performance of batteries to be obtained may markedly vary. Depending on the degree of extension of the electrode layer under the alumina-containing layer, an effect of preventing short circuits by the alumina-containing layer may be insufficient.

The present disclosure has been made to solve the above problems of the conventional technique. That is, it is thus an object of the disclosure to provide a method for manufacturing an electrode sheet from which a sectional shape can be provided where an end of an electrode mixture layer overlies a protective insulating layer at a border between the electrode mixture layer and the protective insulating layer.

A method for manufacturing an electrode sheet according to one aspect of the present disclosure is a method for manufacturing an electrode sheet having a current collector foil, and an electrode mixture layer and a protective insulating layer disposed adjacent to each other thereon, the method having:

a coating material preparation step of preparing an electrode mixture layer coating material obtained by fluidizing components of the electrode mixture layer along with a solvent and a protective insulating layer coating material obtained by fluidizing components of the protective insulating layer along with a solvent,

a coating step of coating the electrode mixture layer coating material and the protective insulating layer coating material, adjacent to each other, on the current collector foil, and

a drying step of drying the electrode mixture layer coating material and the protective insulating layer coating material on the current collector foil after the coating step, wherein

in the coating step, a thickness of the protective insulating layer coating material in coating is made thinner than a thickness of the electrode mixture layer coating material, and

there exists a period in which the electrode mixture layer coating material and the protective insulating layer coating material are present, in contact with each other both in a wet state, on the current collector foil, in a time from the coating step to the drying step.

In the method for manufacturing an electrode sheet according to the above aspect, the electrode mixture layer coating material and the protective insulating layer coating material prepared in the coating material preparation step are coated onto the current collector foil in the coating step. The electrode mixture layer and the protective insulating layer coated are disposed adjacent to each other on the current collector foil. Then, the thickness of the electrode mixture layer in coating is made larger than the thickness of the protective insulating layer. Both the coating materials are in contact with each other still in a wet state at this point, and an end of the thicker electrode mixture layer deforms so as to overhang the thinner protective insulating layer. Thus, by completion of the drying step, a sectional shape is provided where the end of the electrode mixture layer overlies the protective insulating layer at the border between the electrode mixture layer and the protective insulating layer. Accordingly, there is manufactured an electrode sheet electrode mixture layer that has small variations in charge and discharge performance and can provide a sufficient effect of preventing short circuits by the protective insulating layer.

With the present configuration, there is provided a method for manufacturing an electrode sheet from which a sectional shape can be provided where the end of an electrode mixture layer overlies a protective insulating layer at the border between the electrode mixture layer and the protective insulating layer.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view illustrating a state of coating an electrode sheet in an embodiment;

FIG. 2 is a partial sectional view illustrating a sectional shape of the electrode sheet immediately after coating; and

FIG. 3 is a partial sectional view illustrating the sectional shape of the electrode sheet after completion.

### DETAILED DESCRIPTION OF EMBODIMENTS

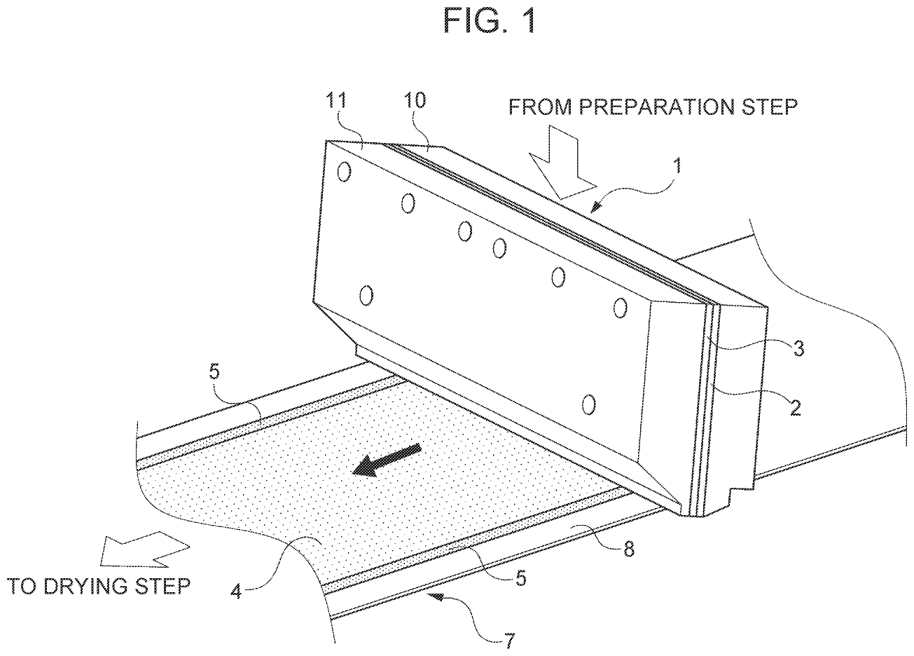

Hereinbelow, an embodiment that embodies the present disclosure will be explained in detail with reference to the drawings. The present embodiment applies the present disclosure to a process of manufacturing an electrode sheet 7 as shown in FIG. 1. FIG. 1 illustrates a coating step of applying coating to a current collector foil 8 with a die coating device 1 to form an electrode mixture layer 4 and a protective insulating layer 5 adjacent to the both sides thereof.

The die coating device 1 in FIG. 1 is a device including two shims 2, 3 interposed between two dies 10, 11. The shim 2 is a member forming a flow path for a coating material of the electrode mixture layer 4, and the shim 3 is a member forming a flow path for a coating material of the protective insulating layer 5. The electrode mixture layer 4 and the protective insulating layer 5 are coated, adjacent to each other, on a surface of a current collector foil 8 with the device 1. The electrode mixture layer 4 and the protective insulating layer 5 can be coated in one step. The coating materials are supplied to the die coating device 1 from a coating material preparation step. The electrode sheet 7 after coating is conveyed to a drying step, where the electrode mixture layer 4 and the protective insulating layer 5 are dried.

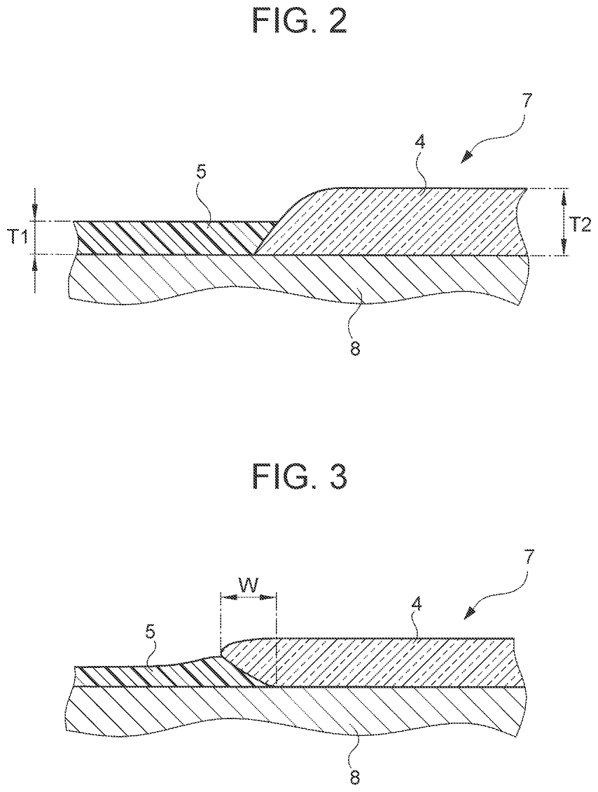

In the present embodiment, with respect to coating thicknesses of the electrode mixture layer 4 and the protective insulating layer 5 in coating with the die coating device 1, the electrode mixture layer 4 is made thicker than the protective insulating layer 5 (T1<T2), as shown in the sectional view of FIG. 2. Accordingly, in the sectional shape in a complete state, as shown in FIG. 3, a portion of the electrode mixture layer 4 overlies the protective insulating layer 5 at a border between the electrode mixture layer and the protective insulating layer. The sectional shape of FIG. 3 may already be provided immediately after coating.

The electrode sheet 7 manufactured by the manufacture process of the present embodiment has the following characteristics according to the sectional shape shown in FIG. 3. First, a coating width of the electrode mixture layer 4 (a dimension in a lateral direction in FIG. 3) can be accurately discerned with optical observation from above. This is because the end of the electrode mixture layer 4 is not obscured by the protective insulating layer 5. For this reason, performance of a battery to be obtained is highly likely to be achieved as intended. Additionally, an effect of preventing short circuits by the protective insulating layer 5 is highly likely exerted as designed. This is because a contact width between the protective insulating layer 5 and the current collector foil 8 is substantially equivalent to a width of the protective insulating layer 5 itself.

In the present embodiment, a flow rate of the coating material for each of the electrode mixture layer 4 and the protective insulating layer 5 is adjusted such that a relationship of the coating thicknesses shown in FIG. 2 is achieved. In other words, the flow rate is determined such that an amount of the coating material to be supplied per coating width is larger for the coating material of the electrode mixture layer 4 than for the coating material of the protective insulating layer 5. This achieves the relationship of the coating thicknesses shown in FIG. 2.

Immediately after coating, the coating material of the electrode mixture layer 4 and the coating material of the protective insulating layer 5 are in contact with each other still in a wet state on the surface of the current collector foil 8. After one coating material is coated and before the other coating material is coated, there is no period in which the coating material first coated is exposed to outside air. This wet state period continues for a while at least after the coating step. For this reason, even when the sectional shape immediately after coating is as shown in FIG. 2, the end of the electrode mixture layer 4 having a larger coating thickness deforms so as to overlie the current collector foil 8. This is because the coating material in a wet state has flowability. Accordingly, the sectional shape as shown in FIG. 3 is provided at completion of the drying step at the latest. The sectional shape as shown in FIG. 3 may be already provided immediately after coating. In such a case, the sectional shape is substantially maintained. Even in a wet state, the coating materials of the electrode mixture layer 4 and the protective insulating layer 5 do not substantially mix and become turbid because of the viscosity of the coating materials.

Examples will be described hereinbelow. In the present Examples, while the thickness of the electrode mixture layer 4 immediately after coating (T2 in FIG. 2, target value) was kept constant, the thickness of the protective insulating layer 5 immediately after coating was set to a plurality of levels (T1 in FIG. 2, target value), and a riding-on width of the electrode mixture layer 4 on the protective insulating layer 5 after the drying step (W in FIG. 3, actual measured value) was evaluated.

Coating Material Preparation Step

Paste-like coating materials for the electrode mixture layer 4 and for the protective insulating layer 5 were produced under the following conditions.

(Coating material of electrode mixture layer 4)
Electrode active material powder: lithium composite oxide for a positive electrode of a lithium ion secondary battery
Additives: binding agent, thickener, and conductive agent
Kneading solvent: NMP
Solid content proportion: 60% by weight

### (Coating Material of Protective Insulating Layer 5)

Insulating material: boehmite
Additives: binding agent, thickener
Kneading solvent: NMP
Solid content proportion: 25% by weight

Coating Step

Current collector foil 8: aluminum foil (12 m-thick)
Conveying speed: 50 m/minute
Target width of the protective insulating layer 5: 3.5 mm
Coating thickness: see Table 1 below

Drying Step

In-furnace temperature: 160° C.
In-furnace residence time: 15 seconds

The coating thicknesses of the electrode mixture layer 4 and the protective insulating layer 5 (T1, T2 in FIG. 2) and the riding-on width of the electrode mixture layer 4 on the protective insulating layer 5 (W in FIG. 3) were actually measured under the conditions described above. A laser displacement meter was placed at a point closer to the coating step between the coating step and the drying step to measure the coating thicknesses in a wet state. A cross section of the electrode sheet 7 subjected to the drying step was observed with a microscope to measure the riding-on width. Measurement results were as in Table 1.

Electrode sheets of numbers 1 to 5 in Table 1 were all produced with the intention of making the coating thickness (T1) of the protective insulating layer 5 smaller than the coating thickness (T2) of electrode mixture layer 4 (Examples). Among these, a sheet having a smaller number has smaller T1, and a sheet having a larger number has T1 closer to T2. An electrode sheet of number 6 in Table 1 as a Comparative Example was produced with the intention of making the coating thickness (T1) equivalent to the coating thickness (T2), although an actual measurement of the coating thickness (T1) is slightly smaller than that of the coating thickness (T2). An electrode sheet of number 7 in Table 1 as a Comparative Example was produced with the intention of making the coating thickness (T1) larger than the coating thickness (T2).

TABLE 1

| Number | T1(μm) | T2(μm) | W(μm) |
|---|---|---|---|
| 1 | 22 | 51.5 | 350 |
| 2 | 23 | 52 | 430 |
| 3 | 27 | 51.4 | 250 |
| 4 | 40 | 51.3 | 180 |
| 5 | 44 | 51.7 | 175 |
| 6 * | 50.6 | 51.8 | ~5 |
| 7 * | 55 | 51.4 | ~5 |

Referring to column W in Table 1, the electrode sheets of numbers 1 to 5 each have a positive value as the riding-on width W. In contrast, in the electrode sheets of numbers 6 and 7, no significant positive value as the riding-on width W was obtained, and the protective insulating layer 5 tended to ride on the electrode mixture layer 4 instead. This is due to a difference in whether the relationship of the coating thickness: T1<T2 was adopted or not.

As described in detail hereinabove, according to the present embodiment and Examples, the electrode mixture layer 4 and the protective insulating layer 5 are formed adjacent to each other on the current collector foil 8 by the coating step. This causes the coating material of the electrode mixture layer 4 and the coating material of the protective insulating layer 5 to be in contact with each other in a wet state on the current collector foil 8 in the time after coating to the drying step. This additionally causes the thickness in coating of the electrode mixture layer 4 to be larger than that of the protective insulating layer 5. Thus, there is achieved a method for manufacturing an electrode sheet, in which the end of the electrode mixture layer 4 overlies the protective insulating layer 5 to complete the electrode sheet 7. For this reason, in the electrode sheet 7 manufactured by the present embodiment, the electrode mixture layer 4 has high accurate charge and discharge performance, and an effect of preventing short circuits by the protective insulating layer 5 is secured.

Further, the present embodiment is a merely example and is not intended to limit the disclosure in any respect. Accordingly, the present disclosure can be naturally improved and modified variously within a scope not departing from the gist thereof. For example, an application object thereof is not limited to the positive electrode of a lithium ion secondary battery, mentioned as an Example. The present disclosure is applicable to not only a negative electrode of a lithium ion secondary battery but also to positive electrodes and negative electrodes of batteries of other types, as long as a process of forming an electrode mixture layer and a protective insulating layer by coating on a current collector foil is included.

The coating device used in the coating step is not limited to the one shown in FIG. 1. A device that coats both the electrode mixture layer 4 and the protective insulating layer 5 with one shim may be accepted. When two shims are used as in the present embodiment, the positional relationship of both upper sides and a downstream side thereof is optional. Further, the device is not limited to a die coating device. It is also not essential to coat both the electrode mixture layer 4 and the protective insulating layer 5 with one coating device, as in the present embodiment. It is only required that the material coated first be not substantially exposed to outside air in the time from the first coating to the second coating. The relationship between the coating thickness (T1) of the protective insulating layer 5 and the coating thickness (T2) of the electrode mixture layer 4 in coating is only required to be T1<T2. In consideration also of significance, T1 is 95% or less of, more preferably 90% or less of T2. The electrode mixture layer 4 and the protective insulating layer 5 may not be in contact with each other in a wet state on a surface of the current collector foil 8 for the entire period after the coating step until the drying step.

What is claimed is:

1. A method for manufacturing an electrode sheet comprising a current collector foil, and an electrode mixture layer and a protective insulating layer disposed adjacent to each other on the current collector foil, comprising:
a coating material preparation step of preparing an electrode mixture layer coating material obtained by fluidizing components of the electrode mixture layer along with a solvent and a protective insulating layer coating material obtained by fluidizing components of the protective insulating layer along with a solvent,
a coating step of coating the electrode mixture layer coating material and the protective insulating layer coating material, adjacent to each other, on the current collector foil, and
a drying step of drying the electrode mixture layer coating material and the protective insulating layer coating material on the current collector foil after the coating step, wherein
in the coating step, a thickness of the protective insulating layer coating material in coating is made thinner than a thickness of the electrode mixture layer coating material in coating, and
there exists a period in which the electrode mixture layer coating material and the protective insulating layer coating material are present, in contact with each other both in a wet state, on the current collector foil, in a time from the coating step to the drying step.
